(19) United States
(12) Patent Application Publication
(10) Pub. No.: US 2005/0056500 A1
(43) Pub. Date: Mar. 17, 2005

(54) Method and apparatus for externally controlling the internal valve components of a shock absorber

(76) Inventor: Timothy A. Garrison, Benton Harbor, MI (US)

Correspondence Address: DEBRA J. FICKLER, 12525 GRANDVIEW DRIVE, HUNTLEY, IL, 60142, US

(21) Appl. No.: 10/795,595

(22) Filed: Mar. 8, 2004

Related U.S. Application Data
(60) Provisional application No. 60/452,453, filed on Mar. 6, 2003.

(51) Int. Cl. F16F 5/00

(52) U.S. Cl. 188/282.2

(57) ABSTRACT

An advanced system externally controlling the internal valve components of a shock absorber is provided. An actuator and controller is utilized to adjust the valving to a predetermined dampening rates as a function of a predetermined event or series of events and independent of the forces acting upon the associated wheel or attaching component.

### FIELD OF THE INVENTION

This application claims priority to provisional U.S. Application Ser. No. 60/452,453, filed Mar. 6, 2003.

The invention relates to a shock absorber used to assist the movement of a vehicle such as a automobile or motorcycle. More specifically, the invention relates to a method for externally controlling the internal components of a shock absorber as a function of an event or series of events and independent of forces acting upon the vehicle.

### BACKGROUND OF THE INVENTION

As used in automobiles and similar wheel driven vehicles, shock absorbers and McPherson struts are typically associated with each wheel and make up a component of the vehicle's suspension system. High horsepower vehicles, such as racecars often use stiffer suspension systems than those of everyday passenger cars to provide a more efficient transfer of energy from the produced by the engine, transferred to a drive shaft which, via a differential, rotates the drive wheels of the vehicle.

Shock absorbers and struts, “shocks,” typically consists of a housing enclosing a piston and a fluid such as oil, compressed air or both. As the piston in the housing moves up and down, the encased fluid moves through a valve. This movement of fluid, through the valve, slows the movement of the piston which in turns, dampens the forces placed on the shock. In passenger vehicle applications, shocks that provide significant dampening are used to provide a smooth ride during cruising operation. These types of shocks are typically non-adjustable.

In racing applications, a shock with a single dampening quality is not preferred. For example, in drag racing, the race vehicle must accelerate from a standing start. At this moment, large torquing forces are applied to the drive wheels of the vehicle. Under these conditions, the wheel or wheels have a strong tendency to spin and the shock attached to the drive wheel will absorb and waste some of these torquing forces. The racer will attempt to select a shock with the optimum dampening properties (“dampening rate”) to increase the downward force as the tire hooks the pavement at the start of the race (referred to as “launch”) to reduce the absorption or waste of force. If too much or too little force is absorbed, the drive tire may spin resulting is a slow start. As such, the racer will select a shock with a dampening rate that assists the launch. However, the optimum dampening rate is often different for the same race vehicle at different tracks. Likewise, changing track conditions such as track temperature, humidity, or stickiness of the starting line, also affects the optimum dampening rate.

To compensate for these differences, shock manufacturers have developed adjustable dampening rate shocks and struts. Single adjustable shocks allow the user to control the extension or “rebound”, of shock whereas double adjustable shocks allow for varying the extension and compress (or “bump”). These shocks typically contain an external manually controlled knob that controls the valving which changes the dampening rate of the piston in the housing. This shocks allow the race to adjust for the specific track and changing track conditions, especially on the starting line. Once the shock has been manually adjusted, it remains at this adjustment until the knob is manually readjusted. Thus, during race conditions the shock remains at the adjusted state during the entire run.

As the vehicle moves down the track, the shock will extend and compress as the drive wheels spin, grab the pavement or “hook,” and transverse bumps. Typically, the race will select a stiff dampening rate for the best launch time at the start of the race. However, as the race vehicle moves over bumps in the track, the stiff shock may not absorb the force and cause the wheel to bounce. During race conditions, wheel bounce often leads to wheel spin and will slow the race vehicle. Therefore, it is desirable to have a shock with changing dampening rates during the course of a race.

Advanced racecars such as Formula 1™ cars often use actively controlled shocks in which a computer monitors the movement of the shock and the amount of wheel spin. The computer will then adjust the dampening rate of the shock to provide optimum driving conditions. However, in many racing applications, such as drag racing sanctioned under the National Hot Rod Association (“NHRA”) and International Hot Rod Association (“IHRA”), and the engine and race vehicle operations may only be monitored by computers, but not actively controlled to adjust to dynamic race conditions. However, a certain events may be controlled based upon time, engine revolutions per minute (“RPM”) or event such as a gear shift of the transmission.

In racing applications that do not allow active monitoring and computer control of the shocks, set-event controllable shocks can be used. These shocks utilize a computer and valving in the shock that is directly linked to the computer to changing the properties of the shock based upon a set event such as time, RPM, or gear shift. These shocks are typically used by well-funded, professional racing teams and are very expensive. The typically sportsman racers and less-funded professional racing teams can not afford these shock systems. In response, race chassis manufactures have developed a mechanical controller which attaches to the rotatable knob on a the shock. However, this mechanical controller has several disadvantages. First, the controller may only be attached to a Koni racing shock. Once attached to the Koni shock, the mechanical controller cannot be removed without removing the shock from the racecar. Thirdly, the available adjustment of the valving is very limiting. For example, the adjustable knob controlling the valving of these shocks typically have twelve settings, the prior art controller may only be used to adjust three setting positions once mounted on the shock.

It is desirable to have a method and apparatus to control the dampening rate of the shock based upon the events during a race. For example, the drag race may desire to have the shock having a stiff dampening rate at the launch and soften as the race vehicle travels down track after a certain amount of time or based upon another event such as a gear shift or change in throttle position. It is desirable for this method and apparatus to be adaptable to race shocks made by many manufacturers such as Koni, Afco, Carrera, Penske and others. Likewise, more adjustability over current shock controllers is desirable and a shock controller that can be removed from the racecar without removing the shock from the racecar is desirable.

### BRIEF SUMMARY OF THE INVENTION

A method for externally controlling the internal valving of an adjustable shock is provided using a variety of embodiments. The disclosed invention is may be utilized with any adjustable shock that provides an external adjustable control mechanism such as a rotatable know or slot. The shock dampening controller may be activated by a pneumatic cylinder controlled by changing fluid pressure such as carbon dioxide or compressed air. Alternatively, electrical control device may be used to actively control the external adjustable shock dampening controller which is activated by a change in electrical voltage.

Various embodiments of the shock dampening controller are disclosed. Each embodiment provides a different location of the actuator controlling the valving adjustable knob of the shock. This allows the racer to adapt the shock dampening controller to shocks made by various manufacturers and to provide clearance for chassis components mounted in the vicinity of the shock. One embodiment of the shock dampening controller provides removability such that the unit may be removed from the shock without removable of the shock from the race vehicle. Lastly, all embodiments of the shock dampening controller may be removed from the shock and mounted on a different shock.

### BRIEF DESCRIPTION OF THE DRAWINGS

FIG. 1 is a perspective view of an adjustable shock with one embodiment of an pneumatically controlled external shock dampening controller with an actuator mounted diagonally across a cylinder of the adjustable shock;

FIG. 2 is a partial perspective view of a second embodiment of an adjustable shock and an external shock dampening controller mounted with an actuator mounted perpendicular to a cylinder of the adjustable shock;

FIG. 3 is a partial perspective view of a third embodiment of an adjustable shock and an external shock dampening controller with an actuator mounted above a cylinder of the adjustable shock;

FIG. 4 is a partial perspective view of a forth embodiment of an adjustable external shock dampening controller with an actuator mounted to a side and perpendicular to a cylinder of the adjustable shock.

### DETAILED DESCRIPTION OF THE INVENTION

In drag racing applications, adjustable shocks preferable. However, it is advantageous to change the dampening rate of the shock at different times during the race. The preferable dampening rate and timing of the changes is often determined by track conditions. Therefore, an apparatus to actively adjust the dampening control mechanism over is provided in various embodiments. Likewise, various controllers are also provided to dictate when the dampening control mechanism. The apparatus, an external shock dampening controller, is removable and may be mounted on many styles of adjustable shocks may by various shock manufacturers. Furthermore, one embodiment of the external shock dampening controller may be mounted and removed while the adjustable shock is on the race vehicle.

FIG. 1 illustrates a conventional adjustable shock 2 with the coil over spring removed (not shown). Shock 2 utilizes an adjustable knob 4 to control the internal valving of shock 2 which, in turn, changes the dampening rate of shock 2. In one embodiment, a shock dampening controller 10 is mounted on the outer cylinder 12 of shock 2 via a collar 14 and is placed near adjustable knob 4. A link attachment 16 receives adjustable knob 4 is secured utilizing a set-screw (not shown) or similar removable mechanical fastener. Link attachment 16 is secured such that as link attachment 16 moves, adjustable knob 4 rotates, thereby changing the dampening properties of shock. Link attachment 16 is also attached to an actuator 18 which actuates link attachment 16 to change the position of adjustable knob 4. Actuator 18 shown in FIG. 1 is controlled using compressed gas and a control valve (not shown). Alternatively, actuator 18 may be an electrically controlled actuator. Both the compressed gas and electrically controlled actuator receive an activation signal from an event controller (not shown). The event controller may be based upon time, such as launch of the run or hundredths of a second after the launch, engine RPM, gear shift or other event occurring during a race.

Link attachment 16, of this first embodiment of shock dampening controller 10, is positioned at approximately 90 degrees to outer cylinder 12. This results in actuator 18 mounting at approximately 15 degrees of the axis of outer cylinder 12. First embodiment of shock dampening controller 10 may be used in racecars with clearance for link attachment 16 and actuator 18 mounted in this configuration.

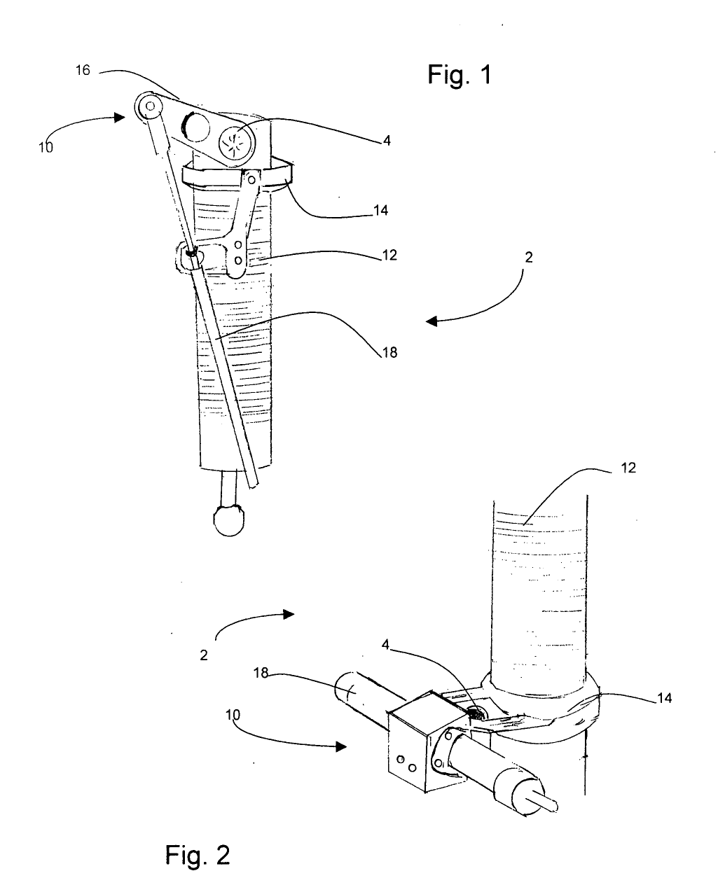

FIG. 2 illustrates an alternative, more compact, second embodiment of shock dampening controller 10. Attachment collar 14 secures shock dampening controller 10 shock to outer cylinder 12. As used in this second embodiment, link attachment 16 sits directly above adjustable knob 4. Link attachment 16, may be removed from adjustable knob 4 after mounting. As shown in FIG. 2, actuator 18 is a cylinder which is actuated by compressed gas to change the position of adjustable knob 4. Alternatively, an electrical or other mechanical actuator may be used. In this second embodiment, collar 14 may be attached outer cylinder 12 of shock 2 without removing shock 2 from the vehicle or racecar.

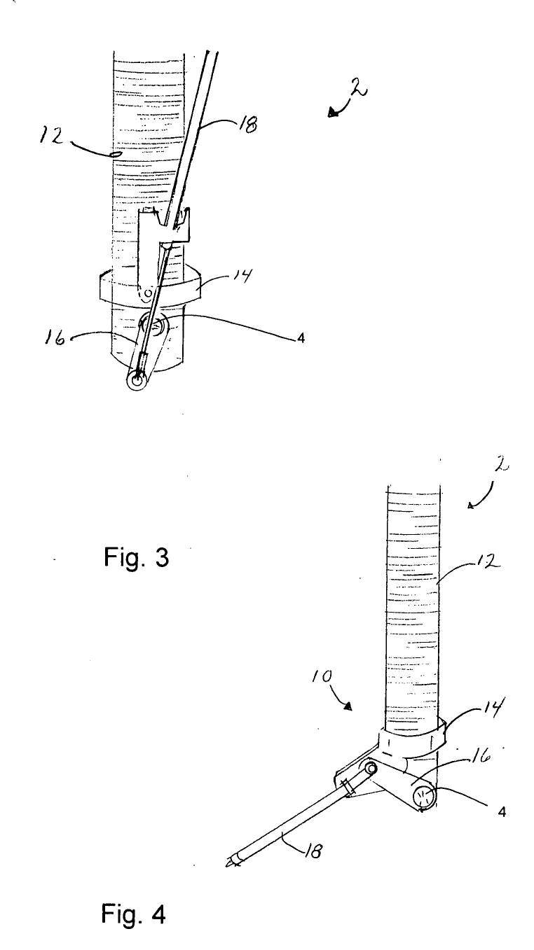

FIG. 3 illustrates a third embodiment of shock dampening controller 10 with actuator 18 mounted at approximately 10 degrees off the axis of outer cylinder 12 of shock 2. To achieve this alignment, link attachment 16 is mounted parallel to the axis of outer cylinder 12 as shown in FIG. 3. Link attachment 16 control is removably mounted on adjustable knob 4 using a set-screw (not shown) or other removable mechanical fastener. Actuator 18 is pneumatically controlled or may be an electrically controlled actuator. When actuator 18 is actuated, link attachment 16 moves and thereby rotates adjustable knob 4 to changing the dampening properties of shock 4. This third embodiment of shock dampening controller 10 may be used in race vehicles where there is little clearance along the axis of shock 2.

FIG. 4 illustrates a forth embodiment of shock dampening controller 10.

This forth embodiment allows for side mounting of actuator 18 as shown in FIG. 4. Link attachment 16 is mounted on adjustable knob 4 at approximately 40 degrees of the axis of outer cylinder 12 of shock 2. However, in this forth embodiment, link attachment 18 may rotate approximately 360 degrees about the axis of outer cylinder 12. As with all embodiments of shock dampening controller 10, actuator 18 may be a pneumatic or electrical actuator. Embodiment four functions as embodiments one and three. This particular embodiment is ideal for race vehicles with clearance problems due to the positioning of fuel cells, tires or slicks, the chassis, wheelie bars, rear end house and other components. This embodiment also provides easy access to actuator 18 for the racer who may experiment with both electrical and pneumatic actuators.

Actuator 18 is actuated upon a predetermined event. In one embodiment, the release of a transmission brake was used at the actuating event. When the transmission break was released, adjustable knob 4 was rotated to a predetermined position to change the dampening properties of shock 2. Another event, such as the passing of time or gear shift may also be used to actuate the adjustable knob 4 to its original or a second predetermined position. These events are received by an electronic controller such as a nitro oxide time, shift timer, shock timer, gear shifter handle with a micro-switch activated by a gear change, micro-switch of transmission brake, RPM switch, micro-switch controlled by the driver, motion switch or other similar devices. The electronic controller sends an electrical signal to electrical actuator 18 to rotate adjustable knob 4 to change the dampening properties of shock 2. Alternatively, the electrical signal is sent to an electrical or pneumatic valve (not shown) which activates pneumatic actuator 18.

All embodiments of shock dampening controller 10, once attached to outer cylinder 16 of shock 2, may be subsequently removed from outer cylinder 16. Likewise, all embodiments provide for nine positional (rotational) changes, out of twelve, of adjustable knob 4. One embodiment, allows for mounting and removing of shock dampening controller 10 when shock 2 is mounted in the racecar or vehicle.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A method for allowing a user to adjust the internal valve components of an adjustable shock absorber via an actuator using predetermined events via a controller, the method comprising:
providing an interface device that allows a user to communicate with a controller via inputs of the device;
inputting a predetermined event in the controller via the interface device;
receiving an indication signaling the occurrence of the predetermined event;
actuating the actuator to control the internal valve components of the shock.

2. The method of claim 1 wherein in the step of actuating the actuator to control the internal valve components of a shock includes adjusting the components up to 100 percent of the adjustable range of the shock absorber.

3. An external shock dampening controller for externally controlling the internal valve components of a shock absorber, the external shock dampening controller comprising:
an adjustable shock absorber having an adjustable external controlling component;
an actuator for actuating the adjustable external controlling component for adjusting the internal valve components of the shock absorber; and
a controller for engaging the actuator.

4. The external shock dampening controller as claimed in claim 3 wherein the controller is a pneumatic actuator.

5. The external shock dampening controller as claimed in claim 3 wherein the controller is an electrical actuator.

6. The external shock dampening controller as claimed in claim 3 wherein the controller is a mechanical actuator.

7. The external shock dampening controller as claimed in claim 3 wherein the external shock dampening controller is removably mounted to a shock absorber.

8. The external shock dampening controller as claimed in claim 3 wherein the external shock dampening controller is mountable on shock absorbers of multiple shock absorber manufacturers.

9. The external shock dampening controller of claim 3 wherein the external shock dampening controller is mounted on a shock absorber after the shock absorber is mounted on a vehicle.

10. The external shock dampening controller of claim 3 wherein the actuator or actuating the adjustable external controlling component is adjustable up to 100 percent of the adjustable range of the external controlling component.
